(19) United States
(12) Patent Application Publication
(10) Pub. No.: US 2011/0033514 A1
(43) Pub. Date: Feb. 10, 2011

(54) Semiochemical emission device

(76) Inventors: James A. Nolen, West Greenwich, RI (US); Robert G. Nelson, Thompson, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/660,452

(22) Filed: Feb. 26, 2010

Related U.S. Application Data
(60) Provisional application No. 61/208,816, filed on Feb. 27, 2009.

(51) Int. Cl. A01N 25/34; A01N 59/04; A01N 59/00; A01N 31/02; A01N 37/00

(52) U.S. Cl. 424/405; 424/84

(57) ABSTRACT

The present invention is directed to a chemical lure, comprising an enclosed container having a top, the top having one or more orifices; a gel matrix contained within the container, the matrix comprising a active ingredient and a carrier; and a headspace between the gel matrix and the top. The emission rate of the active ingredient from the orifices allows the invention to emit volatilized active ingredient for about 60 days.

### CROSS-REFERENCE TO RELATED APPLICATIONS

This application claims the benefit of U.S. Provisional Patent Application Ser. No. 61/208,816 filed Feb. 27, 2009.

### BACKGROUND OF THE INVENTION

1. Field of the Invention

The present invention is directed to semiochemical emission devices, and more particularly to chemical lures that have a controlled emission rate of volatilized active agents.

2. Brief Description of the Related Art

Chemicals of various types have been used in the insect control art for many years, including pheromones, allomones, kairomones, attractants, and repellants. In many cases, these chemicals are mixed with a carrier that allows the chemicals to be handled more easily, and that may permit controlled release of the chemicals over time. Impregnated gels or other semi-solid compositions are known in the art to be useful for this purpose, and are sold commercially under names such as “Prozap”, “Hot Shot”, “No Pest Strip”, “AromaGel”, “MetaGel”, and others. However, the emission patterns of the active chemicals generally follow an initial large burst, followed by a rapid decrease in emission rate. While the initial burst of active chemical is often effective for combating pests, the rapid decrease in emission rate of active chemical that follows the initial burst renders these compositions much less effective over time. What is needed in the art is a composition and device that controls emission of active chemicals so that a predetermined amount of chemical is emitted over time. The present invention is believed to be an answer to that need.

### SUMMARY OF THE INVENTION

In one aspect, the present invention is directed to a chemical lure, comprising an enclosed container having a top, the top having one or more orifices; a gel matrix contained within the container, the matrix comprising a active ingredient and a carrier; and a headspace between the gel matrix and the top.

This and other aspects will be appreciated from a reading of the following description of the invention.

### DESCRIPTION OF THE FIGURES

FIG. 1 is a side view of one embodiment of the invention;

FIG. 2 is a side view of an alternative embodiment of the invention;

FIG. 3 a graph showing gel weight versus time; and

FIG. 4 is a graph showing emission rate versus time.

### DETAILED DESCRIPTION OF THE INVENTION

In one embodiment, the present invention is an article of manufacture that includes an active chemical in a gel matrix and packaged in a container that permits controlled release of said active chemical over time. The article of manufacture is preferably a lure for use in controlling insects and other pests.

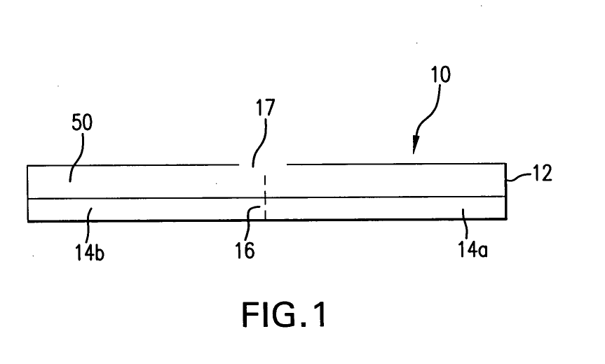

As shown in FIG. 1, the invention 10 includes a container 12 and an active ingredient in a carrier matrix 14a,b. The container 12 is preferably a disposable plastic container having a volume ranging from 10 to about 50 cubic centimeters (cc), and more preferably about 30 cc. An orifice 17 is positioned at the top of the container 12 to allow emission of active agent into the surrounding atmosphere. The size of the orifice can range from about 0.1 mm in diameter to about 10 mm in diameter. One useful size of orifice is about 5 mm (¼ inch). A headspace 50 located above the matrix 14a,b is filled with volatilized active ingredient at about a constant concentration in order to maintain an even dispersal of active ingredient through the orifice 17 over time. The choice of the size of the orifice 17 depends on a variety of factors including the volume of the container 12, the volatility of the active ingredients in the matrix, and the temperature at which the invention will be subjected. Surface area of the matrix 14a,b is also a factor, and can increase as the matrix shrinks over time. In one preferred embodiment, the emission rate of material from the orifice 17 allows the invention to be effective for about 60 days. The invention may be used at ambient temperatures, or may be heated to achieve the desired results. One useful gel matrix is “Icon Gel” available from Agilex (Somerset, N.J.).

Useful active agents include agents useful in pest abatement and control, such as pheromones, kairomones, and kairomone inhibitors. Examples of pheromones include species-specific mating pheromones, such as those for Japanese beetle, potato beetle, coddling moth, boweivel, corn borer, etc., as well as pheromone inhibitors useful, for example, for mating disruption. Examples of kairomones include gases such as carbon dioxide, nitrogen dioxide, as well as substances such as octenol, R-octenol, carboxylic acids, butyric acids, caproic acids, propionic acids, valeric acids, ammonia, and acetone. Examples of kairomone inhibitors include substances such as linalool and d-linalool.

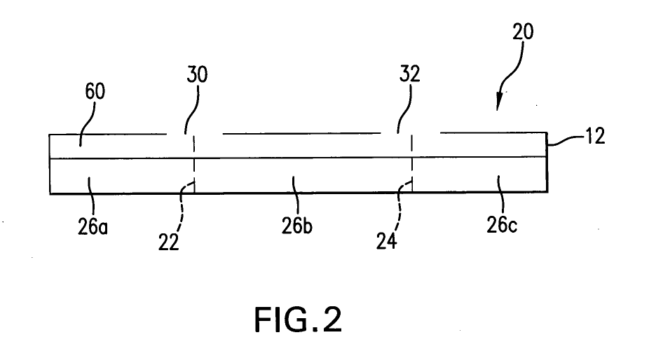

In an alternative embodiment, a divider 16 may be included inside the container 12. The divider 16 divides the container into two sections and allows for the container to hold two carriers that contain incompatible chemicals, but provides for a common headspace 50. For example, as shown in FIG. 1, the container 12 could be divided into two sections and hold a first carrier matrix 14a that contains ammonia, and a second carrier matrix 14b that contains lactic acid. The carriers 14a,b share a common headspace 50 and thus emit from the orifice 17 as a combination that would not be possible if lactic acid and ammonia were mixed into a single matrix. As would be appreciated, the multiple chamber concept may be extended to any number of chambers, as shown in FIG. 2. In FIG. 2, an embodiment of the invention 20 is shown having two dividers 22, 24 and containing three chambers and three gel matrices 26a, 26b, and 26c. Two orifices 30, 32 allow vaporized agents to be released from a common headspace 60.

### Example

Three containers (Series 1, Series 2, and Series 3) each having a volume of 30 cc and an orifice of 0.25 inch were filled with 15 ml of a carrier gel (Icon Gel from Agilex, Somerset, N.J.) containing lactic acid and octenol as active agents. The containers were maintained at room temperature (25° C.) and the weight loss and emission rate were measured at various timer intervals. The data are shown in Table 1.

TABLE 1
Weight Loss

| | Sample No. | | |
|---|---|---|---|
| Date, Time | 1 | 2 | 3 |
| 6/2/08 5:00 PM | 22.453 | 22.933 | 23.157 |
| 6/3/08 4:00 PM | 22.409 | 22.579 | 22.776 |
| 6/5/08 10:00 AM | 21.436 | 22.088 | 22.222 |
| 6/6/08 3:00 PM | 21.142 | 21.828 | 21.941 |
| 6/9/08 2:00 PM | 20.365 | 21.133 | 21.165 |
| 6/10/08 5:00 PM | 19.965 | 20.778 | 20.776 |
| 6/16/08 1:00 PM | 17.946 | 18.958 | 18.800 |
| 6/19/08 5:00 PM | 17.034 | 18.134 | 17.905 |
| 6/23/08 12:00 PM | 15.976 | 17.209 | 16.892 |
| 6/26/08 6:00 PM | 15.052 | 16.386 | 15.994 |
| 7/1/08 12:00 PM | 13.908 | 15.347 | 14.867 |
| 7/2/08 4:00 PM | 13.563 | 15.035 | 14.532 |
| 7/7/08 11:00 AM | 12.640 | 14.184 | 13.618 |
| 7/8/08 4:00 PM | 12.374 | 13.935 | 13.355 |
| 7/9/08 2:00 PM | 12.146 | 13.721 | 13.132 |
| 7/14/08 10:00 AM | 10.928 | 12.531 | 11.894 |
| 7/17/08 4:00 PM | 10.034 | 11.653 | 10.997 |
| 7/18/08 11:00 AM | 9.834 | 11.453 | 10.796 |
| 7/21/08 3:00 PM | 9.404 | 10.699 | 10.096 |
| 7/25/08 9:00 AM | 8.882 | 10.077 | 9.543 |
| 7/28/08 3:00 PM | 8.495 | 9.526 | 9.078 |
| 7/30/08 4:00 PM | 8.317 | 9.207 | 8.843 |
| 8/1/08 5:00 PM | 8.222 | 8.955 | 8.694 |
| 8/4/08 4:00 PM | 8.106 | 8.636 | 8.523 |
| 8/8/08 3:00 PM | 8.066 | 8.439 | 8.451 |
| 8/11/08 3:00 PM | 8.018 | 8.334 | 8.388 |
| 8/13/08 5:00 PM | 7.999 | 8.288 | 8.364 |
| 8/15/08 5:00 PM | 7.990 | 8.260 | 8.351 |
| 8/19/08 10:00 AM | 7.943 | 8.190 | 8.292 |
| 8/26/08 3:00 PM | 7.822 | 8.047 | 8.154 |
| 8/29/08 2:00 PM | 7.758 | 7.973 | 8.083 |
| 9/2/08 4:00 PM | 7.725 | 7.929 | 8.037 |
| 9/4/08 9:00 AM | 7.720 | 7.925 | 8.035 |

| | Emission Rate | | | |
|---|---|---|---|---|
| | Elapsed | Sample No. | | |
| | Time hr | 1 | 2 | 3 |
| 6/2/08 5:00 PM | 0 | 0 | 0 | 0 |
| 6/3/08 4:00 PM | 22 | 0.002 | 0.016091 | 0.017318 |
| 6/5/08 10:00 AM | 64 | 0.015891 | 0.013203 | 0.014609 |
| 6/6/08 3:00 PM | 93 | 0.014097 | 0.011882 | 0.013075 |
| 6/9/08 2:00 PM | 165 | 0.012655 | 0.010909 | 0.012073 |
| 6/10/08 5:00 PM | 192 | 0.012958 | 0.011224 | 0.012401 |
| 6/16/08 1:00 PM | 331 | 0.013616 | 0.012009 | 0.013163 |
| 6/19/08 5:00 PM | 408 | 0.013282 | 0.011762 | 0.012873 |
| 6/23/08 12:00 PM | 498 | 0.013006 | 0.011494 | 0.01258 |
| 6/23/08 12:00 PM | 576 | 0.012849 | 0.011366 | 0.012436 |
| 7/1/08 12:00 PM | 690 | 0.012384 | 0.010994 | 0.012014 |
| 7/2/08 4:00 PM | 718 | 0.012382 | 0.011 | 0.012013 |
| 7/7/08 11:00 AM | 834 | 0.011766 | 0.01049 | 0.011438 |
| 7/8/08 4:00 PM | 862 | 0.011693 | 0.010439 | 0.011371 |
| 7/9/08 2:00 PM | 885 | 0.011646 | 0.010409 | 0.011328 |
| 7/14/08 10:00 AM | 1000 | 0.011525 | 0.010402 | 0.011263 |
| 7/17/08 4:00 PM | 1078 | 0.01152 | 0.010464 | 0.01128 |
| 7/18/08 11:00 AM | 1098 | 0.011493 | 0.010455 | 0.011258 |
| 7/21/08 3:00 PM | 1173 | 0.011124 | 0.01043 | 0.011135 |
| 7/25/2008 9:00 | 1263 | 0.010745 | 0.010179 | 0.010779 |
| 7/28/2008 15:00 | 1341 | 0.010409 | 0.009998 | 0.010499 |
| 7/30/2008 16:00 | 1390 | 0.01017 | 0.009875 | 0.010298 |
| 8/1/2008 17:00 | 1440 | 0.009883 | 0.009707 | 0.010044 |
| 8/4/2008 16:00 | 1510 | 0.009501 | 0.009468 | 0.009691 |
| 8/8/2008 15:00 | 1605 | 0.008964 | 0.009031 | 0.009163 |
| 8/11/2008 15:00 | 1677 | 0.008608 | 0.008705 | 0.008807 |
| 8/13/2008 17:00 | 1728 | 0.008365 | 0.008475 | 0.008561 |
| 8/15/2008 17:00 | 1776 | 0.008144 | 0.008262 | 0.008337 |
| 8/19/2008 10:00 | 1864 | 0.007784 | 0.007909 | 0.007975 |
| 8/26/2008 15:00 | 2037 | 0.007183 | 0.007308 | 0.007365 |
| 8/29/2008 14:00 | 2109 | 0.006968 | 0.007093 | 0.007147 |
| 9/2/2008 16:00 | 2206 | 0.006676 | 0.006801 | 0.006854 |
| 9/4/2008 9:00 | 2247 | 0.006557 | 0.006679 | 0.00673 |

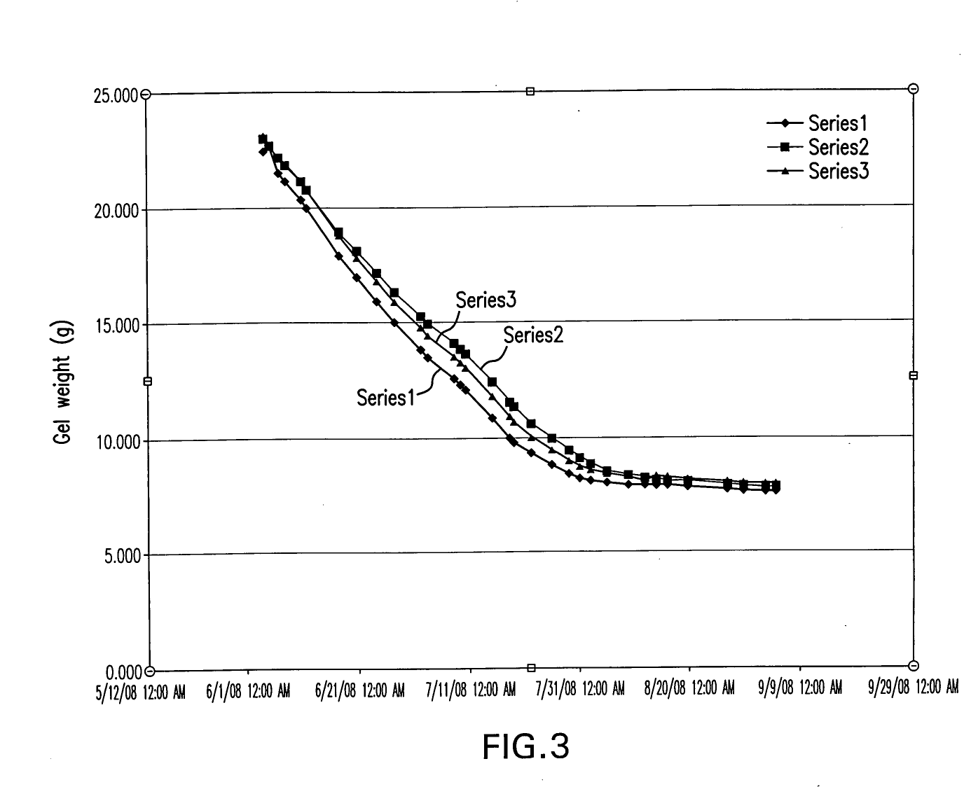

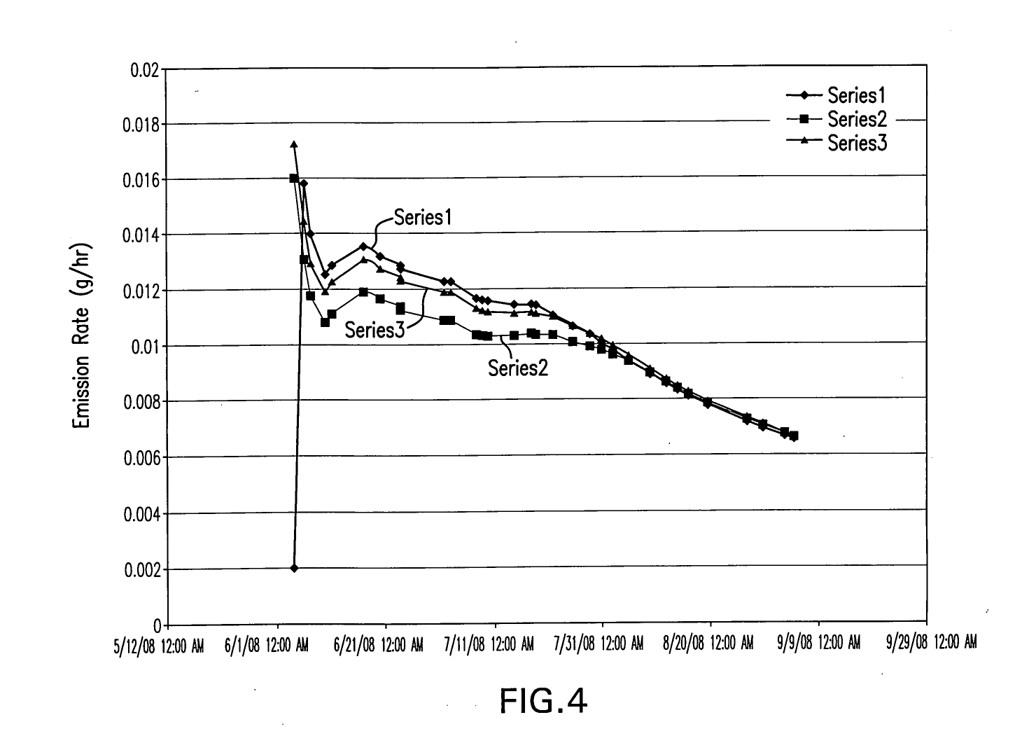

FIG. 3 shows gel weight as a function of time, and FIG. 4 shows emission rate as a function of time. As shown in FIG. 3, the weight of the gel decreases at an even rate for about 60 days. As shown in FIG. 4, the emission rate shows a sharp decline in the first 10 days, and then an approximately level emission rate for the following 50 days.

Although the invention has been shown and described with respect to illustrative embodiments thereof, it should be appreciated that the foregoing and various other changes, omissions and additions in the form and detail thereof may be made without departing from the spirit and scope of the invention as delineated in the claims. All patents, patent applications, and literature publications mentioned are herein incorporated by reference in their entireties.

What is claimed is:

1. A chemical lure, comprising:
an enclosed container having a top, said top having one or more orifices;
a gel matrix contained within said container, said matrix comprising a active ingredient and a carrier; and
a headspace between said gel matrix and said top.

2. The chemical lure of claim 1, wherein said container is a disposable plastic container.

3. The chemical lure of claim 1, wherein the diameter of said one or more orifices range from 0.1 mm to 10 mm.

4. The chemical lure of claim 3, wherein the diameter of said one or more orifices is 5 mm.

5. The chemical lure of claim 1, wherein the volume of said container ranges from 10 cubic centimeters to about 50 cubic centimeters.

6. The chemical lure of claim 1, wherein said headspace contains volatilized active ingredient.

7. The chemical lure of claim 1, wherein said active ingredient is selected from the group consisting of pheromones, kairomones, cairomone inhibitors, and combinations thereof.

8. The chemical lure of claim 1, wherein said active ingredient is selected from the group consisting of carbon dioxide, nitrogen dioxide, octenol, R-octenol, carboxylic acids, butyric acids, caproic acids, propionic acids, valeric acids, ammonia, acetone, linalool, d-linalool, and combinations thereof.

9. The chemical lure of claim 1, further comprising one or more dividers positioned inside said container, said one or more dividers dividing said gel matrix into one or more sections that share a common headspace.
